(19) United States
(12) Patent Application Publication
(10) Pub. No.: US 2025/0097673 A1
(43) Pub. Date: Mar. 20, 2025

(54) METHOD FOR DETERMINING A NEED FOR A MESSAGE CONTENT FOR A STATION

(71) Applicant: Robert Bosch GmbH, Stuttgart (DE)

(72) Inventors: Alexander Geraldy, Hildesheim (DE); Peter Engel, Hessisch Oldendorf (DE); Florian Wildschuette, Hildesheim (DE); Guillaume Jornod, Berlin (DE); Ignacio Llatser Marti, Hildesheim (DE); Philip Wette, Bueckeburg (DE); Yiwen Yang, Hildesheim (DE)

(21) Appl. No.: 18/882,834

(22) Filed: Sep. 12, 2024

(30) Foreign Application Priority Data
Sep. 20, 2023 (DE) 10 2023 209 140.2

(51) Int. Cl. H04W 4/12; H04W 4/40

(52) U.S. Cl. CPC H04W 4/12; H04W 4/40

(57) ABSTRACT

A method for determining a need for a message content for a transmitting station. The method includes: determining an anticipated need for a message content according to one or more receiver stations, wherein the anticipated need with respect to the message content is based on the need of the transmitting station; computing at least one metadata configuration for the message content based on the determining of the anticipated need for the message content; augmenting the message content based on the computed at least one metadata configuration, wherein the metadata configuration specifies in which way the message content is to be adapted dependent on the one or more receiver stations and/or according to a message type to be transmitted.

### CROSS REFERENCE

The present application claims the benefit under 35 U.S.C. § 119 of German Patent Application No. DE 10 2023 209 140.2 filed on Sep. 20, 2023, which is expressly incorporated herein by reference in its entirety.

### FIELD

The present invention relates to a method for determining a need for a message content for a station. Furthermore, the present invention relates to a station, a computer program, and a storage medium for this purpose.

### BACKGROUND INFORMATION

The structure of vehicle-to-everything (V2X) messages is determined by standards developing organizations (SDOs), including the European Telecommunications Standards Institute (ETSI) or SAE International. Certain V2X messages, such as the Cooperative Awareness Message (CAM, ETSI), VRU Awareness Message (VAM, ETSI), Collective Perception Message (CPM, ETSI), or Basic Safety Message (BSM, SAE), have already been standardized.

Presently, V2X data often can originate from crowd-sourced information. The driver still retains responsibility for responding to V2X information, determining the necessity of action such as for example gradually reducing speed based on a collision warning. Due to the absence of robust safety attributes, vehicles might not directly employ V2X data for safety-critical driving actions, such as initiating abrupt braking (Automatic Emergency Braking, AEB) or steering manoeuvres.

The development of safe Cooperative Automated Driving (CAD) systems predominantly revolves around creating a comprehensive system in which safety is ingrained in the overall design. This system might manifest as a safe “closed world” environment, wherein both sender and receiver adhere to the same safety concept and homologation. It could be tailored to a specific use case. An example of such a system is Automated Valet Parking (AVP), which could presently be in the standardization phase at ETSI. Disadvantageously, each time a new vehicle is devised, an entirely new homologation might be mandated for all possible AVP garage/vehicle pairings to ensure safety across all possible combinations.

U.S. Patent Application Publication No. US 2021/219139 A describes a method to increase trust in received V2X data by including metadata on the sender side into the V2X message, such as the vehicle manufacturer, the technical equipment, the vehicle age, implementation details of the hardware and software, and a certification level of the sending vehicle.

PCT Patent Application No. WO 2022/122450 A1 describes the inclusion of a “safety part” in V2X messages to enable their usability for safety-related driving functions. The safety part may include a safety level, failure rate, indication of development process, validity time, error model and/or confidence of the V2X data.

U.S. Patent Application Publication No. US 2023/0059220 A1 describes a method for validating received V2X messages by comparing their data with the same data from another source (e.g., detected object by on-board sensors, plausibility of sender position with RSSI, previous V2X messages).

### SUMMARY

The above object may be solved by a method, a station, a computer program, and a computer-readable storage medium according to features of the present invention. Features, details, and example embodiments of the present invention are disclosed herein. Features and details described in connection with the method according to the present invention also apply to the inventive station, the inventive computer program as well as the computer-readable storage medium and vice versa in each case, so that with respect to the disclosure concerning the individual aspects of the present invention reference can always be made mutually.

The object may be particularly solved by a method for determining a need for a message content for a transmitting station according to the present invention.

According to an example embodiment of the present invention, the method includes the following steps:
Determining an anticipated need for a message content according to one or more receiver stations, wherein the anticipated need with respect to the message content is based on the need of the transmitting station,
Computing at least one metadata configuration for the message content based on the determining of the anticipated need for the message content,
Augmenting the message content based on the computed at least one metadata configuration, wherein the metadata configuration specifies in which way the message content is to be adapted dependent on the one or more receiver station and/or according to a message type to be transmitted.

This allows to advantageously improve a more effective interpretation of the received data, which consequently prevents potentially leading to hazards for example in relation to a safety-critical scenario in traffic. Further, this has the advantage that the inventive method enables a faster decision-making at runtime, for example whether data is fulfilling the requirements of a receiver station or receiver and furthermore if the received data is qualified for a road traffic related function. Further, the inventive method enables the improvement of existing road traffic related applications for example with respect to traffic safety, driver assistance and/or automated driving applications. An anticipated need in this context can be understood as a foreseeable requirement or necessity of a potential receiver based on requirements or circumstances related to vehicular movement and/or transportation infrastructure and/or pedestrian movement.

It is possible that the method according to an example embodiment of the present invention comprises the further following steps:
Aggregating the at least one metadata configuration dependent on the one or more receiver stations and/or on a use case, wherein the use case defines a scenario related to the station, wherein the scenario comprises a sequence of actions and interactions that take place between the station and a system to accomplish a task,
Assembling the metadata based on the aggregated metadata configuration, and
Sending the message content comprising at least the assembled metadata and/or payload data.

This allows a significant improvement in relation to the interpretation and/or analysis of the received information from a potential receiver station.

It is further possible that during the determining, the method according to an example embodiment of the present invention comprises at least one of the further following steps:
Determining the anticipated need for the message content according to one or more receiver stations, wherein the anticipated need with respect to the message content is based on information with respect to the one or more receiver stations,
Determining the anticipated need for the message content according to one or more receiver stations, wherein the anticipated need according to the one or more receiver stations is based on semantic information from the environment of the transmitting station and/or from an environment of the one or more receiver stations based on a map.

This may have the advantage that the delivery or transmission of relevant data to a receiver station can be significantly increased regarding its reliability, quality and/or accuracy. This allows advantageously to anticipate for example the driving tasks of the station and to decide which data/metadata is necessary for a receiver. In other words: it can make a big difference, if a sender and a receiver are part of the same environment, for example both are on the same motorway, or one is on the motorway and the other is on a parking lot. Further, this allows improving the anticipation of the receivers' needs based on the knowledge of their position, their behaviour, and their driving tasks.

It is a possibility that the method according to an example embodiment of the present invention comprises the further following steps:
Generating a profile for the at least one metadata configuration,
Selecting the profile based on requirements for the message content related to the transmitting station and/or based on the information from the one or more receiver stations and/or from an environment of the one or more other stations based on a map, wherein the profile specifies a predefined function of the station and/or a predefined use case for the station.

This may allow a faster and better usage of the metadata configuration for a more tailored utilisation of data for the receiver.

It is possible that the method according to an example embodiment of the present invention comprises the further following step:
Eliminating at least one part of payload data based on the computed at least one metadata configuration, wherein the computed at least one metadata configuration indicates a low value of information for the payload data.

This allows a more efficient and faster transmitting of the message content based on the adapted payload.

It is possible that the method according to an example embodiment of the present invention comprises the further following step:
Storing the at least one metadata configuration according to the one or more receiver stations and/or according to the message type to be transmitted.

This has the advantage that storing different metadata configurations enables to accommodate varying requirements and conditions without the need for frequent modifications or adjustments. By maintaining different metadata configurations specific settings can be readily accessed and applied as needed, facilitating efficient adaptation to different scenarios. Further, this allows to enhance flexibility, and enables rapid response to changing circumstances while maintaining precision and consistency in operations.

It is further possible that the message type is a vehicle-to-everything message.

The utilization of a vehicle-to-everything (V2X) message allows to facilitate comprehensive and precise communication within the context of road traffic.

A V2X message can enable a seamless communication between vehicles, infrastructure, pedestrians, and other elements within the traffic environment. Further this allows to improve situational awareness and safety. Furthermore, a usage of a V2X message provides advantageously real-time data about traffic conditions, road hazards, weather, and other relevant factors, allowing vehicles to make informed decisions promptly. Further, a V2X message can increase the performance of an advanced driver assistance systems (ADAS) and/or autonomous driving capabilities. This means that a V2X message can advantageously warn drivers of potential collisions, reducing accidents and enhancing road safety.

In another aspect of the present invention, a computer program may be provided, in particular a computer program product, comprising instructions which, when the computer program is executed by a computer of a station, cause the computer to carry out the method according to the present invention. Thus, the computer program according to the present invention can have the same advantages as have been described in detail with reference to a method according to the present invention.

In another aspect of the present invention, a station may be provided, which is configured to execute the method according to the present invention. As the station, for example, means like a computer can be provided which executes the computer program according to the present invention. The computer may include at least one processor that can be used to execute the computer program. Also, a non-volatile data memory may be provided in which the computer program may be stored and from which the computer program may be read by the processor for being carried out.

According to another aspect of the present invention a computer-readable storage medium may be provided which comprises the computer program according to the present invention and/or instructions which, when executed by a computer of a station, cause the computer to carry out the steps of the method according to the present invention. The storage medium may be formed as a data storage device such as a hard disk and/or a non-volatile memory and/or a memory card and/or a solid state-drive. The storage medium may, for example, be integrated into the computer of the station.

Furthermore, the method according to the present invention may be implemented as a computer-implemented method.

Further advantages, features and details of the present invention will be apparent from the following description, in which embodiments of the present invention are described in detail with reference to the figures. In this context, the features mentioned in the description may each be essential to the present invention individually or in any combination.

### BRIEF DESCRIPTION OF DRAWINGS

FIG. 1 shows a method, computer program, a storage medium and apparatus according to embodiments of the present invention.

FIG. 2 shows a method according to embodiments of the present invention.

FIG. 3 shows a method of a message flow and adaptation of data/metadata set according to embodiments of the present invention.

FIG. 4 shows a method of a computation of data/metadata set and usage of the updated set according to embodiments of the present invention,

FIG. 5 shows a signed Station Metadata Set according to embodiments of the present invention.

FIG. 6 shows a Public Key Infrastructure according to embodiments of the present invention.

FIG. 7 shows a Signed TX Station Data Message according to embodiments of the present invention.

FIG. 8 shows a Signed TX Station Data Message with Metadata according to embodiments of the present invention.

FIG. 9 shows a Flow Diagram of a verification sequence according to embodiments of the present invention.

FIG. 10 shows a sequence diagram of a method according to embodiments of the present invention.

FIG. 11 shows a method with a vehicle and a smart traffic light according to embodiments of the present invention.

FIG. 12 shows a method with a station and two vehicles according to embodiments of the present invention.

FIG. 13 shows a sequence diagram of a method according to embodiments of the present invention.

FIG. 14 shows a sequence diagram of a method with a database version check according to embodiments of the present invention.

FIG. 15 shows a sequence diagram of a method wherein options are provided according to embodiments of the present invention.

FIG. 16 shows a method with a vehicle and a smart traffic light according to embodiments of the present invention.

### DETAILED DESCRIPTION OF EXAMPLE EMBODIMENTS

V2X communication may stand for “Vehicle-to-Everything” communication. It is particularly a technology framework that enables communication between vehicles and various elements of the transportation ecosystem, including other vehicles (V2V), infrastructure (V2I), pedestrians (V2P), cyclists (V2C), and more. One goal of V2X communication may be to improve road safety, traffic efficiency, and overall transportation system effectiveness by allowing vehicles and other entities to exchange information in real-time. This technology may have applications in advanced driver assistance systems (ADAS), autonomous driving, traffic management, and various other aspects of modern transportation. The transmission of V2X messages through V2X communication might facilitate the exchange of information between vehicles and/or infrastructure components and/or pedestrians.

This messaging exchange can also empower the operation of current road traffic related applications aiming to enhance traffic safety, efficiency, driver comfort, and bolster the dependability of existing driver assistance and automated driving applications. Illustrative instances encompass Cooperative Automated Cruise Control (C-ACC) and V2X-linked collision warnings (e.g., due to an impending traffic congestion or a pedestrian crossing a roadway).

Metadata may refer to data that provides information about other data. It may describe various attributes of the primary data, such as its origin, format, creation date, authorship, and other relevant details. Metadata may help in organizing, understanding, and managing the primary data, whether it's a document, image, video, or any other type of information. On the other hand, descriptor may refer to a term or label that is used to describe or identify a specific characteristic or quality of something. It may also be used in the context of linguistics or programming, where it represents a description or identifier for a specific entity or concept. In summary, while both metadata and descriptor involve descriptions and information, metadata particularly pertains to information about other data, whereas descriptor generally refers to a label or term used to describe a particular aspect or quality of something.

Payload data may refer to the essential information or content that is being conveyed within a data packet or message. It represents the actual data that carries meaning or value, distinct from any additional metadata or control information.

A road traffic related function is defined as a specific operation or task that is directly associated with the flow and/or management of traffic on roads. This function can encompass the exchange of data and information between vehicles (V2V), infrastructure (V2I), or pedestrians (V2P) facilitating real-time communication to enhance road safety, traffic efficiency, and/or overall transportation effectiveness. In certain road traffic scenarios, a road traffic related function can be related to a safety-critical scenario such as for example an emergency brake scenario or an avoidance maneuver situation or a collision warning scenario.

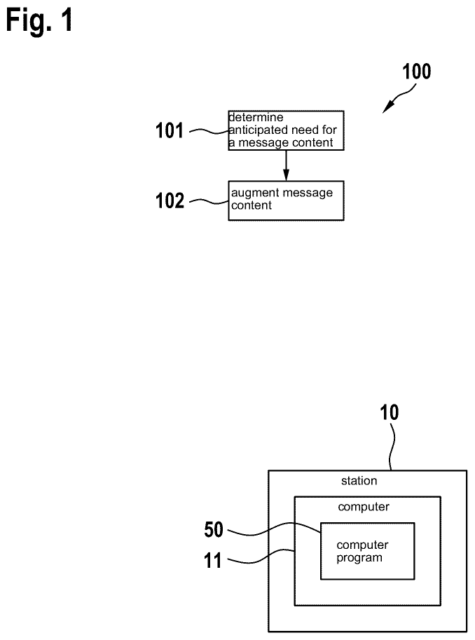

FIG. 1 depicts a method, a computer program, a storage medium and a station according to embodiments of the present invention. FIG. 1 shows a method 100 for determining a need for a message content for a transmitting station 10. The method 100 comprises the following steps:

In step 101 an anticipated need for a message content according to one or more receiver stations 20, 30 is determined. The anticipated need with respect to the message content is based on the need of the transmitting station 10. In step 102 at least one metadata configuration for the message content is computed based on the determining step 101 for the message content. Then, in step 103 the message content is augmented based on the computed 102 at least one metadata configuration. The metadata configuration specifies in which way the message content is to be adapted dependent on the one or more receiver stations 20,30 and/or according to a message type to be transmitted.

In another embodiment (not shown in FIG. 1) the anticipation of the need may be based on a set of receivers, for example a number of receivers, vehicle types, manufacturers, traffic behaviour, separation of traffic flows, map information, and/or possible use-cases.

FIG. 1 further shows a station 10, which comprises a computer 11 and a computer-readable storage medium 15. The computer-readable storage medium 15 comprises a computer program 50.

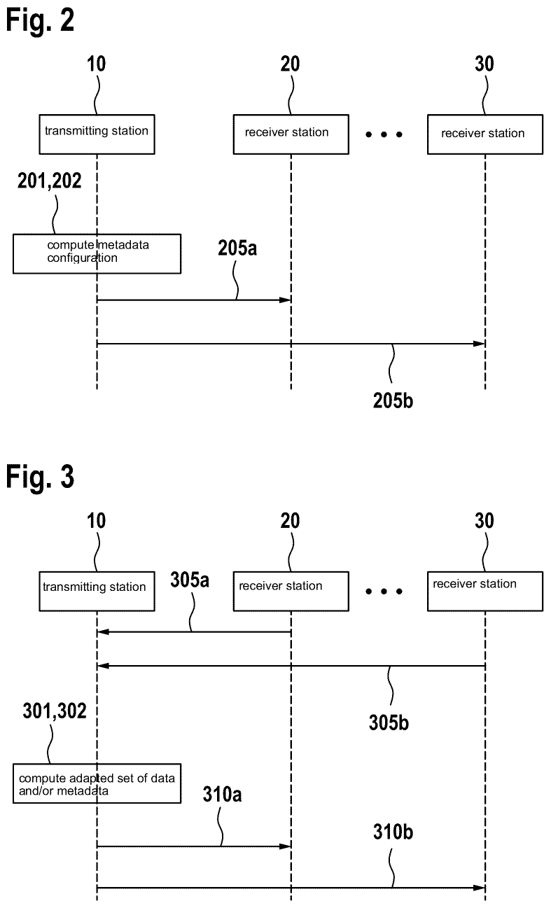

According to the embodiment shown in FIG. 2, a station 10 may perform the following steps. In step 202, a metadata configuration may be computed based on the anticipated need, which was determined in step 201. The computing may be done at any time before sending a message needing the metadata. It may be run periodically, when any new information influencing the metadata selection is available from the station 10 itself or received from elsewhere, or when starting to send a message and the metadata configuration is really needed. The station 10 may anticipate the needs for metadata according to possible receivers. In a basic setup, the station 10 may also use information from and about itself. This information may include for example a position, speed, vehicle type, current and/or upcoming driving tasks, and/or modes (automation levels). The information may further include environmental conditions like temperature, light, and weather conditions and/or design decisions or use cases implemented in the station 10 to derive or anticipate which requirements one or more possible receivers of V2X data of the station 10 may have and which requirements the station 10 could fulfil.

Based on this anticipation, the station 10 may define 201 a metadata configuration used for future V2X messages sent by the station 10. This configuration may be computed 202 and stored separately for different receivers and for different message types. In step 205a, 205b, the metadata configuration may be used when sending a message to another station 20, 30.

Further, the station 10 may use the computed metadata configuration for the message type and addressed receiver(s) 20, 30 to assemble the configured metadata and add it to the V2X message. If multiple metadata configurations are needed, i.e., for multiple use cases, message types or receivers, the station 10 may aggregate the metadata configurations before assembling the metadata. The station 10 may then send 205a, 205b the overall V2X message comprising usual headers, the payload data, and the assembled metadata.

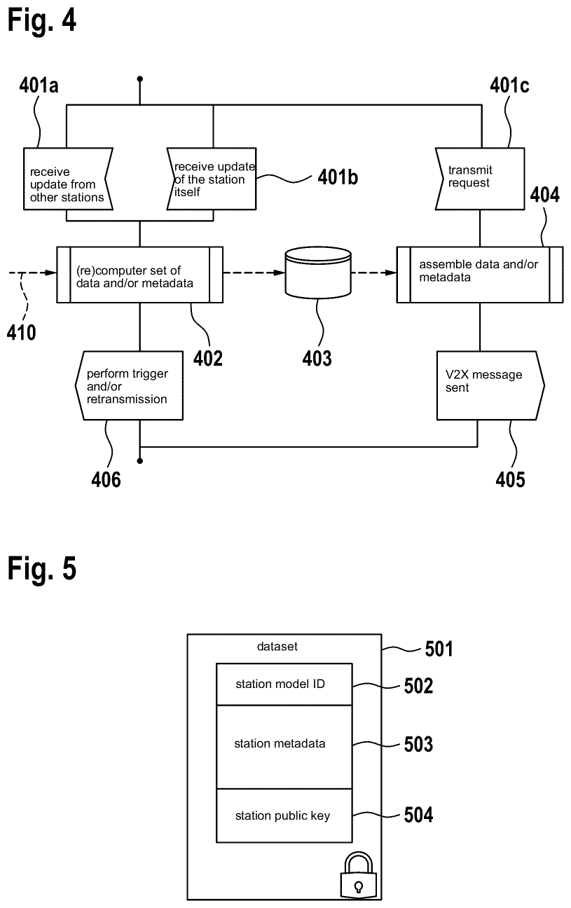

FIG. 4 shows these two steps with some additions according to embodiments of the present invention. On the left side of the flow chart, it is depicted that in a step 401a, an update is received from other stations 20, 30. Further, in a step 401b, an update of the station 10 itself comprising the above mentioned metadata information may be received. According to a step 410, a map may be used for receiving map-related data, as will be discussed hereinbelow in more detail. In a step 402, the set of data and/or metadata is (re) computed, which may result in a selected set of data and/or metadata 403. In an optional step 406, a trigger and/or retransmission of V2X messages may be performed if data and/or metadata has changed. On the right side of the flow chart, it is depicted that a step 401c is performed according to which a V2X message transmits a request from other stations 20, 30. In a next step 404, data and/or metadata is assembled in accordance with the defined set of data and/or metadata 403. In a next step 405, the V2X message is sent.

FIG. 3 shows the embodiment of FIG. 2 with some modifications. The station 10 receives in step 305a, 305b a message from the other stations 20, 30. The message may be a V2X message. Then, in step 301, 302, an adapted set of data and/or metadata may be computed based on the knowledge about the other stations 20, 30 with respect to the received message in step 305a, b and the environment with respect to their determined needs. In a further step 310a, 310b, the V2X message may be sent to the receiving stations 20, 30 using the adapted set of data and/or metadata.

In one embodiment, the station 10 may use information received from other stations 20, 30 via a V2X message such as for example a Cooperative Awareness Message (CAM), a VRU Awareness Message (VAM), a Collective Perception Message (CPM) and/or a Manoeuvre Coordination Message (MCM). In general, using any V2X message comprising information about the sending stations 20,30 like for example location, behaviour, station type, their environments, and/or the traffic participants in these environments. This information may be received and accumulated without having a dedicated information exchange for the metadata generation. The station 10 may use this received information to know about the presence of potential receivers or potential receiver stations and to improve the anticipation of the receivers' needs, knowing their position, behaviour and driving tasks. If station 10 sends (back) V2X messages with data and metadata configurations similar to the received message, it may also reflect the needs of the respective stations 20, 30.

In another embodiment, the station 10 may use a map, which may be stored in the station 10 or connected via network, to have semantic information about an environment, for example a road type, intersections, restrictions, driving speeds, connectivity to other roads, traffic lights, lane information, and about an environment of possible receiver stations 20, 30. This may help to anticipate the driving tasks of the receiver stations 20, 30 and to decide which data/metadata is necessary for a receiver 20, 30. It may make a difference, if a sender 10 and a receiver 20, 30 are part of the same environment, for example if both are on the same motorway, or if, for example, one is on the motorway and the other is on a parking lot. In the same way, stations near or on intersections and the number of stations that could be further information sources may influence the metadata configurations.

In another embodiment, for computing the metadata configuration, profiles may be used, which are predefined for relevant functions and use cases. The selection of a profile may then be made using all the information mentioned above, e.g., based on the information about possible receivers, for example profile definition and selection on a driving scenario like approaching or leaving intersection, right or left turn or straight, scenario complexity like a highway or urban scenario.

In another embodiment, not only the metadata is configured. The station 10 may eliminate parts of the payload data if the metadata configuration for that part of the data indicates a low value of information.

A method according to an embodiment of the present invention comprises the following steps. The included data during the generation of a V2X message for transmission may often be a result of a measurement, e.g., a relative distance to a detected object via the vehicle's on-board sensors, or an estimation, e.g., the absolute position of the sender estimated by its positioning unit. In addition to this data, the transmitter may add safety metadata to the generated message. The metadata may include a confidence description for each measured or estimated data in the V2X message. For each of these values, the standardized V2X messages may typically include a confidence indication, representing the estimated absolute accuracy of the value with a default confidence level of 95%. However, this confidence indication may not be enough for the receiver to decide whether the V2X data may be used for a road traffic related function, in particular for a safety-critical driving function. An alternative may be to match the series of measured or estimated values to a probability density function (PDF) by means of probability distribution fitting. This may be done, e.g., during the calibration process of the vehicle measurement and/or estimation systems. The PDF may be described as metadata in the V2X message by indicating the distribution type and characterized by its parametrization. In this way, the receiver may have a much better knowledge of the accuracy of the V2X data and may check if it fulfils the requirements of its current driving function. For example, the receiver may require that a certain position in the V2X data is located within a given lane with at least a probability p. This condition may be checked by evaluating the PDF of the corresponding position in the received V2X data. Additionally, confidence intervals may be calculated for parametric PDFs.

In case the V2X data may be used for driver assistance or automated driving functions, the receiver may require the knowledge of the set of operating conditions under which the system measuring or estimating the transmitted V2X data operates safely. These may include environmental, geographical and time of day constraints, traffic and roadway characteristics, and the vehicle automation level. The receiver may then check if these operating conditions include its current driving conditions. In this case, it may use the received V2X data for its driving function.

During the generation of a V2X message, typically not all the data measured or estimated by the transmitted may be included in the V2X message. Instead, the transmitter may select a subset of this data to be included in the generated message, e.g., by means of message generation rules. Metadata may be used to describe the completeness of the included data in the V2X message, i.e., the scope of the included data with respect to the total amount of measured or estimated data by the transmitter. The receiver may then check if the amount of included V2X data exceeds a minimum amount required by the receiver, or if the included V2X data includes specific data items or regions required by the receiver.

Regarding information about the estimated Quality of Service (QOS) that the receiver may expect from the V2X communication link, metadata may be used to describe a QoS level, or the value of one or several QoS metrics.

A consistency value may indicate the probability that the measured or estimated data is correct. A low consistency value may indicate that the data may represent an erroneous estimation or an invalid measurement, e.g., a perceived non-existent (ghost) object. The consistency value may be calculated by estimating the distance between the measured or estimated data and its true value, e.g., from a map, or the value of a previous time instant or Kalman filter predicted values. Algorithms, such as deep learning (DL) and machine learning (ML) may also be applied to predict values and calculate the data consistency.

The receiver may receive the V2X message and interpret its safety metadata in order to determine the suitability for its current driving function. By processing the metadata, it may determine whether the received V2X data fulfils the requirements of its current driving function and may therefore be used as input for this function. Otherwise, the receiver may not be able to rely on the V2X data alone for its driving function. The V2X data may still be used e.g., as a redundancy check in addition to data obtained from a different source.

The description of the confidence values for V2X data may include the definition of a probability density function type that most closely matches the distribution of the measured or estimated data. Each distribution type may be defined by a set of statistical parameters, which may allow to calculate the probability of the real value being within an arbitrary range of values.

Some examples of probability density functions may be the following. A Normal or Gaussian distribution characterized by its mean or expectation μ and its standard deviation σ. A log-normal distribution characterized by the mean or expectation μ and the standard deviation σ of the variable's natural logarithm. A pareto distribution characterized by its scale parameter xₘ and its shape parameter α. A continuous uniform or rectangular distribution characterized by its minimum value A and its maximum value B. A Poisson distribution characterized by its rate λ. An exponential distribution characterized by its rate λ. A gamma distribution characterized by its shape k and its scale θ. A Rayleigh distribution characterized by its scale θ. A Rice (or Rician) distribution characterized by its scale σ and the distance between its reference point and the centre of the distribution.

The operating conditions of the system that measured or estimated the transmitted V2X data may include environmental, geographical and time of day constraints, traffic and roadway characteristics, and the vehicle automation level. Some examples of these conditions are the following. The environmental conditions may include weather, e.g., sunny, cloudy, light rain, storm, snow, ice, fog, smog, and illumination, e.g., minimum and maximum illuminance level. Geographical constraints may include specific regions, such as countries, states, school areas, construction sites, yards, parking lots and the like. Time of day constraints may refer to allowed operation hours, e.g., from 8:00 to 18:00 or specific moments, e.g., sunrise, sunset, night. Traffic characteristics may include traffic density (vehicles/km/lane) and/or vehicle types (cars, trucks/tractors, buses, motorcycles). Roadway characteristics may include roadway types, e.g., street, rural road, motorway, divided/undivided road, number of lanes per direction, and road surfaces, e.g., asphalt, concrete, gravel road, cobblestone, offroad. A vehicle automation level may include, e.g., longitudinal automation, lateral automation, level of driving automation according to SAE J3016. An equipment of physical infrastructure may include, e.g., traffic lights on post/gantry, sensors (video, radar, LiDAR).

The completeness of measured or estimated V2X data may be described in the following ways. It may be described by a number of measured or estimated items/objects included in the message and/or total number of measured or estimated items/objects by the transmitter. It may be described by (a) geographical region(s) covered by the measured or estimated data included in the V2X message. It may further be described by (a) geographical region(s) not covered by the measured or estimated data included in the V2X message. It may also be described by a ratio between the amount of measured or estimated data included in the V2X message and the total amount of data measured or estimated by the transmitter.

The estimated Quality of Service (QOS) of a V2X communication link may be described and included in the V2X message metadata with the following metrics and mechanisms.

A Message rate, which may describe a repetition frequency or frequency range with which the V2X message is transmitted, in case that the message transmission is (semi-) periodic. A number of repetitions may describe a number of times that the message is transmitted (may be undefined for periodic messages that are transmitted indefinitely).

A message counter may be incremented by one every time for each V2X message transmitted, it allows the receiver to detect possible message losses. Error detecting and/or correcting codes may be added to the V2X message to enable the receiver to detect transmission errors, e.g., parity bit, checksum, cyclic redundancy check, cryptographic hash function, or correct them, e.g., forward error correction, hybrid automatic repeat request. The transmitted message may include its measured channel load, e.g., channel busy ratio, so that the receiver may better estimate the current channel state, which may have a direct impact in the expected V2X communication performance. The transmitted message may include its average measured latency, i.e., the time interval between message generation and actual message transmission. This latency may mainly arise from the time that the transmitter needs to buffer the generated message while the V2X channel is sensed to be busy, e.g., using the CSMA/CA medium access control protocol. The receiver may use the measured latency to better estimate the current channel state. The transmitted message may also include its measured channel reliability, e.g., average packed error rate of received V2X messages, so that the receiver may better estimate the current channel state. Instead, or additionally, a QoS level, e.g., a value between 0 and 1, may be calculated from one or more of the described metrics and included in the V2X message metadata.

The consistency value of measured V2X data may be calculated in different ways. If a sensor perceives an object outside its perception area, the object may not exist, and it may have been perceived due to a measurement error. In this case, the measured object may have a low (or zero) consistency value. If a perceived object is detected by several independent sensors and/or is also perceived through received V2X data, such as a Cooperative Awareness Message, and it is located within the perception area of all these sensors, the object may have a high existence probability. Therefore, the measured object would have a high consistence value. If an object has been perceived for a long time, it may have a high existence probability and vice versa. If the data of a perceived object is within a plausible range of the Kalman filter predicted values, e.g., future position, speed, acceleration data, heading etc., it may have a high existence probability and vice versa. By analysing data from vehicle sensors and historical records, deep learning (DL) and machine learning (ML) may also be applied to predict values and calculate the data consistency.

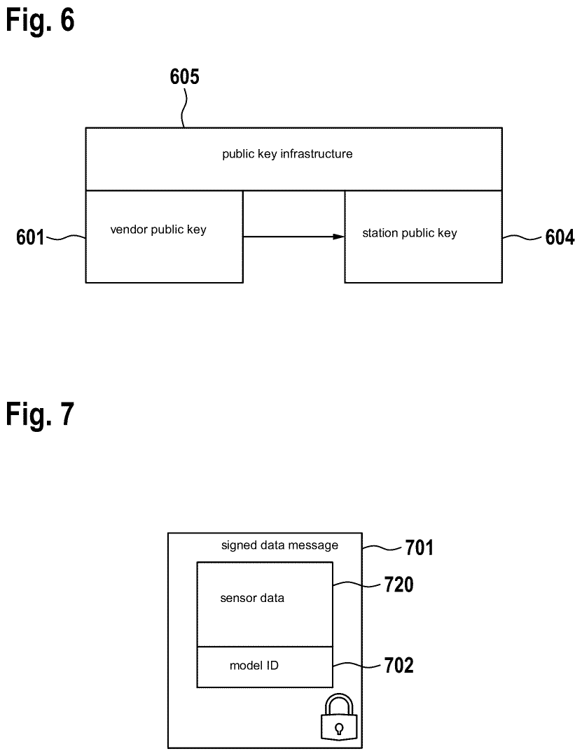

In the following, possible prerequisites are described. At the time of putting a station in service, its sensors and data fusion systems may be registered to the central registry with metadata describing the quality and conditions of the data provided. Optionally, design assumptions may also be stored in the metadata. For later verification of the authenticity the station's public key 504, 604 may also be included. All data included in a dataset 501 may be signed using a vendor's private key, which is shown in FIG. 5 and FIG. 6. The signed station metadata set 501 depicted in FIG. 5 may comprise a station model ID 502, station metadata 503 and a station public key 504.

FIG. 6 shows a public key infrastructure 605 according to an embodiment, in which a vendor public key 601 may be used to derive a station public key 604.

In this embodiment shown in FIG. 6, the station's public key 604 is not contained in the station metadata set 501. The station's public key 604 is delivered using the public key infrastructure 605.

FIG. 7 shows a signed data message 701 of a station 10 according to an embodiment. The signed data message 701 comprises sensor data 720 and a model ID 702. According to this embodiment the station 10 prepares a data message 701 by getting the sensor data 720, attaching the station model identifier (Model ID) 702 and signs the V2X message 701 using the station's private key.

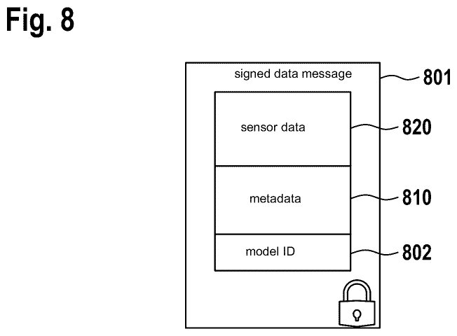

FIG. 8 shows a signed data message of the station with metadata according to an embodiment. In this embodiment in contrary to FIG. 7 the signed data message 801 comprises the sensor data 820, the model ID 802 and additionally metadata 810.

Each station 10, 20, 30 may store a local copy (cache) of the central registry containing all metadata signed using a certificate, so that it may not be necessary to exchange data with the central registry at every V2X data transmission. The cache may be updated regularly.

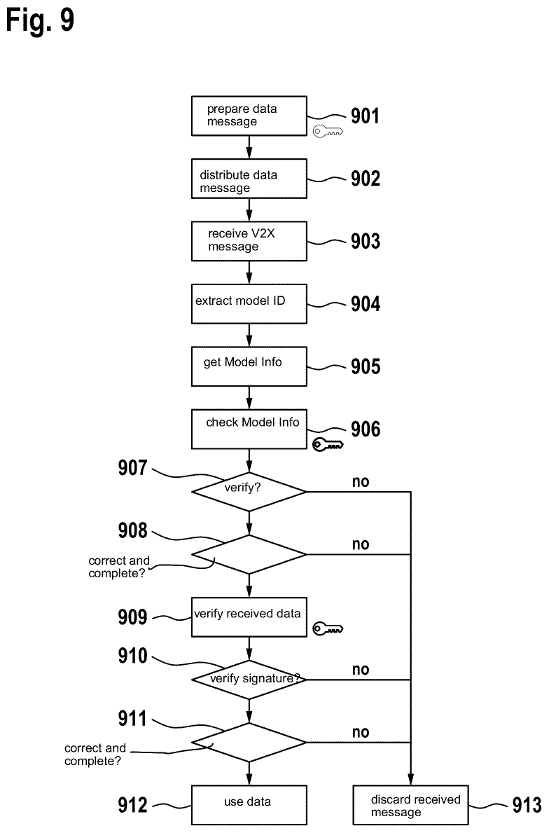

The method according to an embodiment of the present invention may comprise the following steps, which are depicted in FIG. 9. In step 901, a transmitting station 10 may prepare a data message by getting the sensor data, attaching the station model identifier (Model ID) and may then sign the V2X message using the station's private key. In step 902, the transmitting station 10 may distribute the data message through V2X. In step 903, a receiving station 20 may receive the V2X message. In step 904, the receiving station 20 may extract the Model ID of the transmitting station 10 from the received message. In step 905, the receiving station 20 may get the Model Info corresponding to the Model ID from the cached central registry. If the certified trustworthiness information corresponding to the transmitting station 10 is not found in the local registry, the receiving station 20 may request an up-to-date copy of the central registry. If the receiving station 20 is out of coverage, or if the certificate is not found in the new version of the registry, the receiving station 20 may reject the incoming information. In step 906, the receiving station 20 may check the Model Info using the vendors public key (cached or online available). In step 907, if the signature of the vendor can't be verified, the received message may be discarded 913. In the other case, the receiving station 20 may reliably know the transmitting station 10 vendor. Thus, the receiving station 20 may reliably get the correct public key for transmitting station 10. In step 908, additionally, during the verification of the signature of the Model Info, the receiving station 20 may check the correctness and completeness of the content. If the Model Info is incomplete, changed, or incorrect, the received data message may be discarded 913. In step 909, the receiving station 20 may have the correct Model Info for the transmitting station 10. Using the contained Station Public Key of the transmitting station 10, the receiving station 20 may verify the received data message. In step 910, if the signature of the transmitting station 10 couldn't be verified, the received message may be discarded 913. In the other case, the receiving station 20 may reliably know the transmitting station 10. Thus, the receiving station 20 may reliably get the correct public key for the transmitting station 10. In step 911, additionally, during the verification of the signature of the data message, the receiving station 20 may check the correctness and completeness of the content. If the data message is incomplete, changed, or incorrect, the received data message may be discarded 913. In step 912, the receiving station 20 may now reliably know that the transmitting station 10 has sent the data, the data message is complete and correct and the receiving station 20 may be in hands of the correct Station Metadata of the transmitting station 10. The receiving station 20 may now use the data and validate the possible usage of received data using the Station Metadata of the transmitting station 10 and the safety requirements of the dedicated safety-critical function.

In another embodiment, the metadata may be related to different levels of aggregation, for instance point clouds and/or perceived objects.

In another embodiment, there may be an additional step of checking the age of the certificate and to discard the associated data if their certificate is too old. The age of information may be corresponding to the time since the issue of the certificate.

In another embodiment, the certificate may be related to a public or private key that enables the station to sign and encrypt the data in addition to certifying the quality of the sent data.

In another embodiment, the data message 801 contains additional, e.g., spatial or scene dependent, metadata, which is shown in FIG. 8.

In another embodiment, the Station Model ID may point to a look-up table where several single Metadata about e.g., sensors, fusion components, hardware information, software information may be separately stored.

In another embodiment, the Model ID may correspond to the Vehicle Identification Number (VIN).

In another embodiment, another approach for authentication and signature of messages may be used, such as group-keys.

In another embodiment, if it isn't feasible to keep all station models worldwide in the local cache of registry, only a subset of registered models may be cached locally like the registered models in a region (e.g., EU).

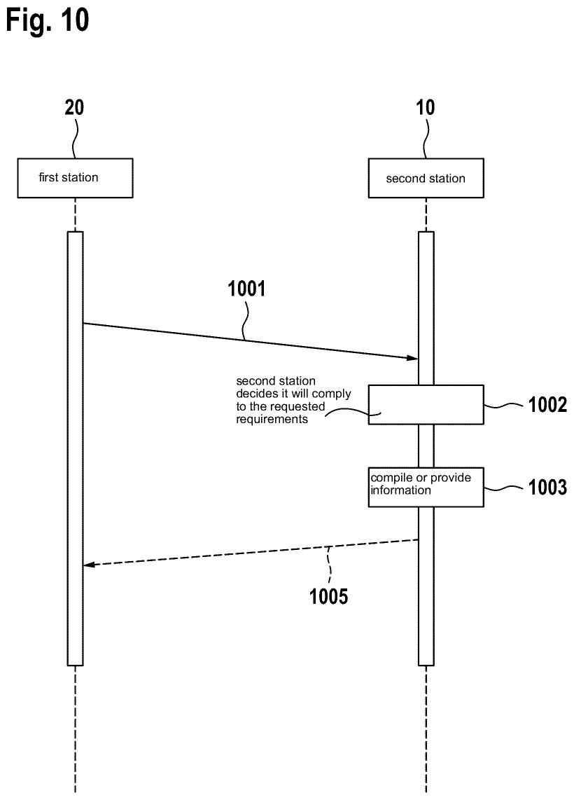

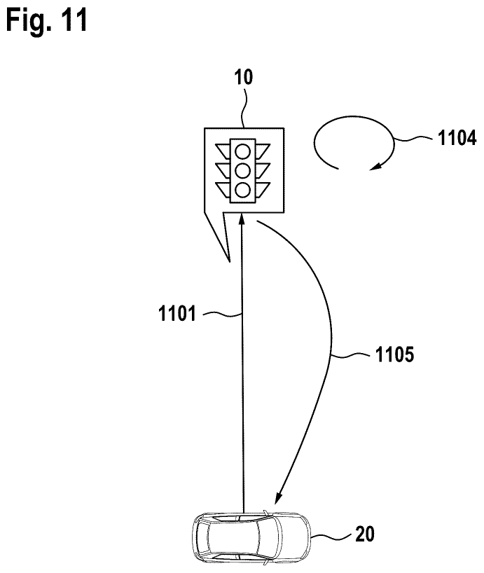

A method according to embodiments of the present invention is depicted in FIG. 10 and may comprise the following steps. In step 1001, a first station 20 may distribute its requirements for V2X information that will allow it to operate its function in a functional-safety compliant manner. A second station 10 may receive the requirements from the first station 20. In step 1002, the second station 10 may decide based on an examination of the received requirements whether it will comply to the requested requirements, and abort if not. In step 1003, the second station 10 may compile or provide the information according to the requirements based on a positive decision. In a further optional step, the second station 10 may add a flag to the information to indicate that it fulfils the requirements (not shown). In step 1005, the second station 10 may transmit the compiled information to the first station 20.

The first station 20 may receive the information from the second station 20, check whether the information meets its requirements and, if so, forward the information to its function.

Further, the requirements sent by the first station 20 and checked by the second station 10 may comprise the following elements. One element may be Operational Design Domain (ODD), which may describe operating conditions like road types, speeds, weather conditions and/or relevant traffic participants. Another element may be functional requirements (for example accuracy of measured or estimated values (e.g., position, speed, acceleration, yaw rate, dimension, angle, object type, trajectory), accuracy of time source (e.g., GPS time, network time protocol), [min, max] vehicle speed). Another element may be Quality of Service (QOS) requirements (for example a payload in [min, max] bytes, maximum tolerable delay, or data age in [min, max] msec, data rate in [min, max] Mbps). Another element may be required redundancy levels (for example information update rate, minimum number of uncorrelated information sources). Another element may be safety levels and qualifications (for example Automotive Safety Integrity Level (ASIL) for the system development of the sender). Another element may be allowed failure and degradation modes (for example a capability of detecting sensing degradation, such as sensor blindness, de-calibration, or misalignments. A requirement may comprise degraded constraints (e.g., reduced perception range by bad/poor weather conditions)).

According to one example, which is illustrated in FIG. 11, a vehicle 20 (the second station in this example) is given, which may be running a function requiring an environmental model following specific requirements regarding the content of the environmental model. The specific requirements may comprise the following aspects. A bounding box of the surrounding vehicles may be within 100 m of the station and within 10 m of a road. A position of the centre of gravity of the surrounding vehicles may be within 100 m of the station and within 10 m of a road with an accuracy of 2 m in a specific projection and coordinate reference system. A position of the surrounding vulnerable user may be within 100 m of the station and within 10 m of a road with a 50 cm accuracy in a specific projection and reference system. Vegetation may be considered as points and buildings may be considered as polygons. A station 10, a smart traffic light in the embodiment of FIG. 11, may be running a function that is creating an environmental model from many sources and is able to provide a large range of information with different granularity and to perform the following operations. One operation may be a lidar cloud points acquisition. Another operation may be an image acquisition from front, back and side cameras. Another operation may be radar measurements. Another operation may be a data fusion of sensor measurements and perceived objects. Another operation may be an object detection and classification. Another operation may be a creation of layers. Another operation may be a projection in different coordinate systems.

In step 1101 of the embodiment of FIG. 11, the vehicle 20 may send its requirements to the station 10, which may be able to comply with the requests and format the information in step 1104 in a way that all requirements of the vehicle 20 are fulfilled. In step 1105, the formatted information may be transmitted to the vehicle 20. There may also be an advantage in terms of channel usage over sending all raw data.

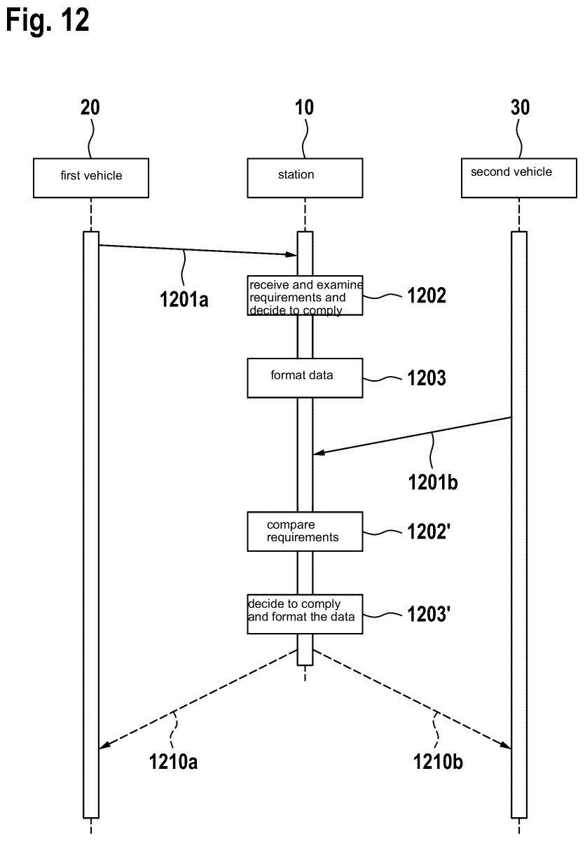

According to another embodiment depicted in FIG. 12, a first vehicle 20 may send its requirements in step 1201a. A station 10 may receive these requirements, examine the requirements, and decide to comply with the requirements in step 1202. The station 20 may format the data in step 1203 and send it to the vehicle 20 according to the requirements in a further step 1210a. Later, a second vehicle 30 may send its requirements in step 1201b. The station 10 may compare both requirements of the first and the second vehicle in step 1202′ and determine that the requirements of the first vehicle 20 are included in the requirements of the second vehicle 30. The station 10 may decide to comply with the requirements of the second vehicle 30 and format the data according to the requirements of the second vehicle 30 in step 1203′. The station 10 may then send the formatted data to the first vehicle 20 and the second vehicle 30, or broadcast it, in step 1210a, 1210b. Since the requirements of the first vehicle 20 are included in the requirements of the second vehicle 30, the function of the first vehicle 20 may use the data although it is complying with the requirements of the second vehicle 30.

According to an embodiment (not depicted), a first vehicle may send its requirements R1, and a second vehicle may send its requirements R2. A third vehicle may receive both requirements R1 and R2, examine them and decide to comply with R1 and R2. In order to avoid sending two sets of data (one fulfilling R1 and one fulfilling R2), the third vehicle may calculate the minimum set of requirements R3 that fulfils both R1 and R2. If the third vehicle can comply with the requirements R3, it may format the data accordingly and send it. The first vehicle and the third vehicle may receive the V2X data and use it for their driving functions, since it may fulfil both their requirements. If the third vehicle cannot comply with the requirements R3, but it can comply with R1 and/or R2, it may format the data according to R1 and/or R2 and send it.

Instead of aborting, when a second station can't fulfil the requirements, it may alternatively send a rejection message to inform the first station. Whether the second station rejects silently or with a rejection message may depend on a given use-case.

The transmitting station 20 may send more than one set of requirements (optionally in a prioritized list), if there are different possibilities or trade-offs to fulfil the function. The receiving station 10 may then check if one or another set of requirements can be fulfilled, increasing the chance to fulfil at least one set of requirements. If the list of requirement sets is prioritized, the station 10 may check the requirement sets from highest to lowest priority, in order to find the set of requirements with the highest priority which can be fulfilled. The station 10 may then fulfil the requirements of the station 20 if at least one set of requirements from the station 20 can be fulfilled by the station 10.

The transmitting station 20 may tag each set of requirements with a unique label before sending it. When the receiving station 10 can fulfil one or more requirement sets, the receiving station 10 may include the unique labels of the fulfilled requirement sets into the message for the transmitting station 20. When the transmitting station 20 receives the information from the receiving station 10, the included labels may help the transmitting station 20 to check which requirements are fulfilled. The transmitting station 20 may forward the information and the label of the fulfilled requirements to the function.

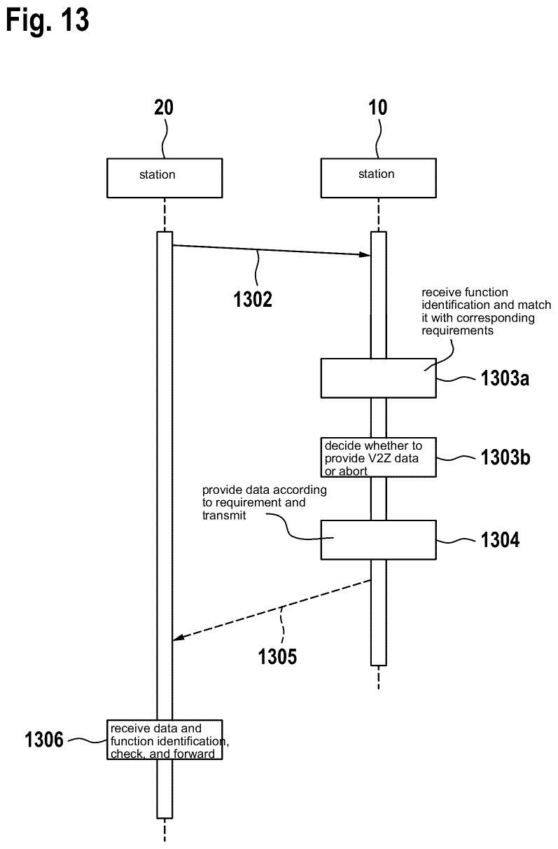

A method according to an embodiment of the present invention is shown in FIG. 13 and comprises the following steps. In step 1302, a station 20 may transmit the identification of its current driving function. In step 1303a, a station 10 may receive the function identification and match it with the corresponding requirements in its internal database. In step 1303b, the station 10 may decide whether it is able to provide V2X data according to the requested requirements, and abort if not. In step 1304, the station 10 may provide the data according to the requirements of the station 20 and transmit the information to the station 20 along with the function identification received from the station 20 associated to the set of requirements according to step 1305. In step 1306, the station 20 may receive the data and function identification from the station 10, check whether its requirements are met and, if so, forward the information to its current driving function.

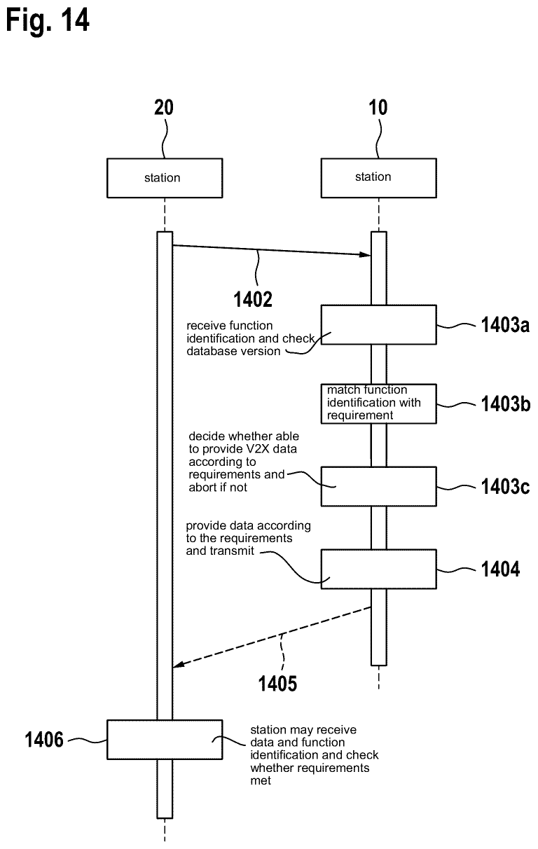

FIG. 14 shows another embodiment of a method according to the present invention which comprises the following steps. In step 1402, a station 20 may transmit the identification of its current driving function and a database version. In step 1403a, a station 10 may receive the function identification and check the database version. In step 1403b, the station 10 may match the function identification with the corresponding requirements in its internal database. In a further step 1403c, the station 10 may decide whether it is able to provide V2X data according to the requested requirements, and abort if not. In step 1404, the station 10 may provide the data according to the requirements of the station 20 and transmit the information to the station 20 along with the function identification received from the station 20 associated to the set of requirements according to step 1405. In step 1406, the station 20 may receive the data and function identification from the station 10, check whether its requirements are met and, if so, forward the information to its current driving function.

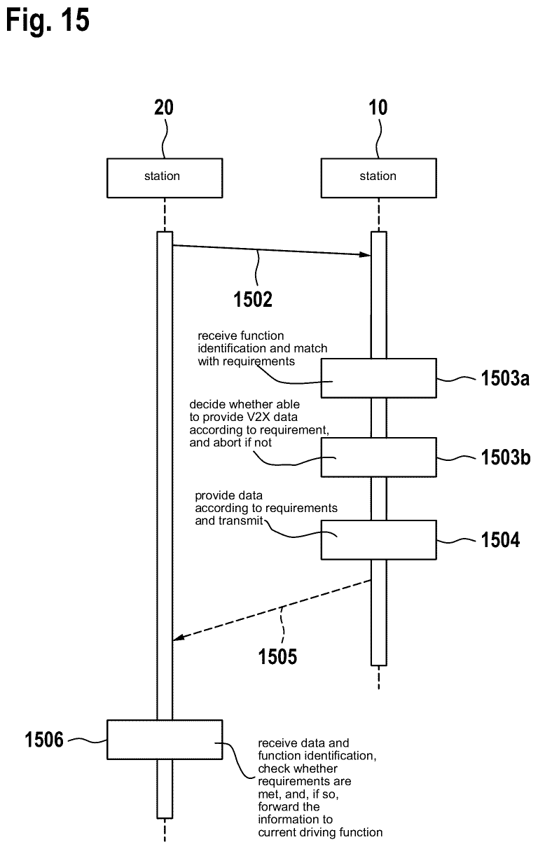

FIG. 15 shows another embodiment of a method according to the present invention which comprises the following steps. In step 1502, a station 20 may distribute the identification of its current driving function with further options. In step 1503a, a station 10 may receive the function identification and match it with the corresponding requirements in its internal database while considering said provided options. In step 1503b, the station 10 may decide whether it is able to provide V2X data according to the requested requirements, and abort if not. In step 1504, the station 10 may provide the data according to the requirements of the station 20 and transmit the information to the station 20 along with the function identification received from the station 20 associated to the set of requirements according to step 1505. In step 1506, the station 20 may receive the data and function identification from the station 10, check whether its requirements are met and, if so, forward the information to its current driving function.

The requirements may be based on public standard, and may, for instance, be stored in a database that is responsible for the management and access to the requirement information. This database may, for instance, be in the station 10,20, and/or in a central server. The requirements associated to the function identification in the database may comprise the following. One requirement may regard Operational Design Domain (ODD), which may describe operating conditions like road types, speeds, weather conditions and/or relevant traffic participants. Another requirement may regard functional requirements (for example an accuracy of measured or estimated values (e.g., position, speed, acceleration, yaw rate, dimension, angle, object type, trajectory), an accuracy of time source (e.g., GPS time, network time protocol), [min, max] or a vehicle speed). Another requirement may regard Quality of Service (QOS) requirements (for example a payload in [min, max] bytes, maximum tolerable delay, or data age in [min, max] msec, data rate in [min, max] Mbps). Another requirement may regard required redundancy levels (for example an information update rate, minimum number of uncorrelated information sources). Another requirement may regard Safety levels and qualifications (for example an Automotive Safety Integrity Level (ASIL) for the system development of the sender). Another requirement may regard allowed failure and degradation modes (for example a capability of detecting sensing degradation, such as sensor blindness, de-calibration, or misalignments. Requirements in this context may comprise degraded constraints (e.g., reduced perception range by bad/poor weather conditions)).

The identification of the function may be an alpha-numerical identifier.

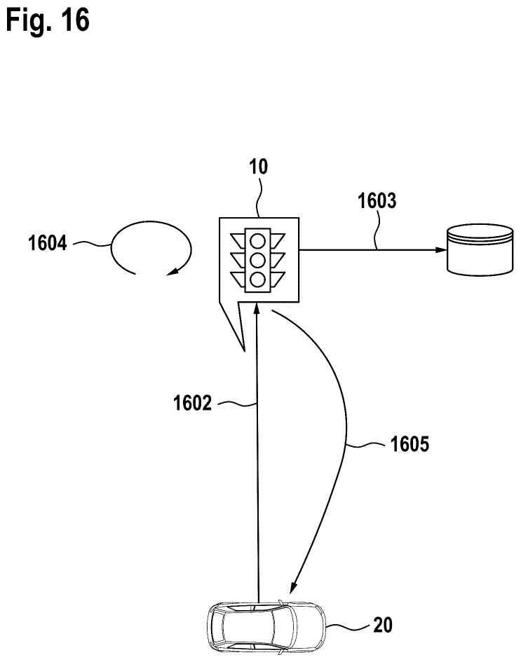

A first example may be given in conjunction with FIG. 16 with a vehicle 20 running an automated driving function requiring an environmental model following specific requirements regarding its content. One specific requirement may describe a bounding box of the surrounding vehicles within 100 m of the station and within 10 m of a road. Another specific requirement may describe a position of the centre of gravity of the surrounding vehicles within 100 m of the station and within 10 m of a road with an accuracy of 2m in a specific projection and coordinate reference system.

Another specific requirement may describe a position of the surrounding vulnerable user within 100 m of the station and within 10 m of a road with a 50 cm accuracy in a specific projection and reference system. According to another specific requirement vegetation may be described as points and buildings as polygons. An entity 10, for example a smart traffic light in the illustration of FIG. 16, may be running a function that is creating HD maps from many sources and may be able to provide a large range of information with different granularity and to perform the following operations. One operation may be a lidar cloud points acquisition. Another operation may be an image acquisition from front, back and side cameras. Another operation may be radar measurements. Another operation may be a data fusion of sensor measurements and perceived objects. Another operation may be an object detection and classification. Another operation may be a creation of layers. Another operation may be a projection in different coordinate systems.

According to the embodiment shown in FIG. 16, the vehicle 20 may transmit a function identifier to the entity 10, for example a smart traffic light, in step 1602. The entity 10 may check a database in step 1603. In step 1604, the entity 10 formats its data to meet the requirements of the vehicle 20. In step 1605, the entity 10 sends the formatted data to the vehicle 20.

FIG. 16 particularly shows an example of a vehicle 20 sending its function identifier to a smart traffic light 10 that may format its environmental model data to meet the requirements of the vehicle 20 and send a formatted environmental model to the vehicle 10.

A public or published standard, which may be implemented as the database gathering all requirements, particularly maps the function to its requirement. The following depicts an example extract of the database:

| | | Map requirement |
|---|---|---|
| Function ID | Map requirements | value |
| . . . | | |
| AD80 | Vehicle BB | NULL |
| AD80 | Accuracy of the | 2 |
| | position of the enter | |
| | of Gravity of | |
| | surrounding vehicles | |
| | in m | |
| AD80 | Center of Gravity | RD/83 |
| | reference system | |

RD/83, ETRS89 and 42/83 may be three German reference standards that may be used. The vehicle 20 may only send AD80, an exemplary function which may be autonomous driving version 80, as identifier of its function identifier. Receiving this identifier, the entity 10 may query the requirements from the database and check the requirements. The entity 10 may be able to comply with the requests and compile the information for the vehicle 20. FIG. 16 illustrates this example.

In another embodiment, the public standard may list multiple options for each function in the database. The reference to the option may be distributed together with the identification in the first step 1502, according to the embodiment illustrated in FIG. 15.

Multiple options may be chosen by the vehicle 20, either as a combination (AND), or a choice (OR). When the entity 10 receives options as choice (OR), it may select one requirement set and continue the process with this set. Preferably, the options are labelled, which may allow the entity 10 to indicate which requirements it is complying to when sending the qualified information to the vehicle 20.

In another example, each function may have options as depicted in the following example extract of the database.

| | | Map | |
|---|---|---|---|
| Function ID | Option | requirements | Map requirement value |
| . . . | | | |
| AD80 | | Vehicle BB | NULL |
| AD80 | | Center of Gravity | 2 |
| | | accuracy in m | |
| AD80 | 1 | Center of Gravity | RD/83 |
| | | reference system | |
| AD80 | 2 | Center of Gravity | ETRS89 |
| | | reference system | |
| AD80 | 3 | Center of Gravity | 42/83 |
| | | reference system | |

The function of the vehicle 20 may require RD/83 as reference standard. As a result, the vehicle 20 may send option 1 together with its ID in the first step 1502, as shown in FIG. 15.

In another embodiment, there may be no request from a first station 20. The entity 10 may choose the set of requirements in the database that matches its data and may then distribute the identifier referencing this set of requirements in the database along with the data. A possible receiver may then be able to decide if the requirements are met by the entity 10 and referenced in the V2X message to fulfil its own requirements and if the data may then be used.

In another embodiment, the standardized requirements may not be linked to a function identification but have unique identifications for each requirement. Stations may cherry pick their requirements in the database and then reference sets of individual requirements in their transmission, with or without requests.

In a similar situation as described above, stations may cherry pick individual requirements as shown in the example extract of the database below.

| Requirements | | |
|---|---|---|
| # | Map requirements | Map requirement value |
| 1 | | |
| 2 | Vehicle BB | NULL |
| 3 | Center of Gravity | 2 |
| | accuracy in m | |
| 4 | Center of Gravity | RD/83 |
| | reference system | |
| 5 | Center of Gravity | ETRS89 |
| | reference system | |
| 6 | Center of Gravity | 42/83 |
| | reference system | |
| 13 | Ego-vehicle speed | >20 km/h |
| 14 | Ego-vehicle speed | <130 km/h |

For example, the function of the vehicle 20 may require RD/83 as Centre of Gravity reference standard, and the ego-vehicle speed may have to be between 20 and 130 km/h. As a result, it may select the requirement identification 4, 13 and 14 and send them via V2X communication.

In another embodiment, the identification may be sent along with a version number of the database it is referring to. This may allow to ensure the compatibility between the databases of the stations. This is shown in FIG. 14.

The receiving station 10 may have been last updated in 2020 whilst the transmitting station 20 may have been last updated in 2023. In 2020, the version 17.2 of the standard may have been published. In 2023, a new version 18 may have been published.

The transmitting station 20 may therefore refer to the version 18 when it is distributing its function identifier. The receiving station 10 may receive this identifier together with the used version and realize that the versions are not compatible. It may therefore abort the process.

An alternative may be to answer with the version of the receiving station 10, so that the transmitting station 20 may analyse if it would be able to accept the requirements that are stored in the lower version (17.2) in our example. The process may then continue with the lower database version.

The above explanation of the embodiments describes the present invention in the context of examples. Of course, individual features of the embodiments can be freely combined with each other, provided that this is technically reasonable, without leaving the scope of the present invention.

What is claimed is:

1. A method for determining a need for a message content for a transmitting station, comprising the following steps:
determining an anticipated need for a message content according to one or more receiver stations, wherein the anticipated need with respect to the message content is based on a need of the transmitting station;
computing at least one metadata configuration for the message content based on the determining of the anticipated need for the message content; and
augmenting the message content based on the computed at least one metadata configuration, wherein the metadata configuration specifies in which way the message content is to be adapted dependent on the one or more receiver stations and/or according to a message type to be transmitted.

2. The method of claim 1, further comprising the following steps:
aggregating the at least one metadata configuration dependent on the one or more receiver stations and/or on a use case, wherein the use case defines a scenario related to the station, wherein the scenario includes a sequence of actions and interactions that take place between the station and a system to accomplish a task;
assembling the metadata based on the aggregated metadata configuration; and
sending the message content including at least the assembled metadata and/or payload data.

3. The method of claim 1, wherein, during the determining, at least one of:
the anticipated need with respect to the message content is based on information with respect to the one or more receiver stations;
wherein the anticipated need according to the one or more receiver stations is based on semantic information from an environment of the transmitting station and/or from an environment of the one or more receiver stations based on a map.

4. The method of claim 3, further comprising the following steps:
generating a profile for the at least one metadata configuration,
selecting the profile based on requirements for the message content related to the transmitting station and/or based on the information from the one or more receiver stations and/or from the environment of the one or more other stations based on the map, wherein the profile specifies a predefined function of the station and/or a predefined use case for the station.

5. The method of claim 1, further comprising the following step:
eliminating at least one part of payload data based on the computed at least one metadata configuration, wherein the computed at least one metadata configuration indicates a low value of information for the payload data.

6. The method of claim 1, further comprising the following step:
storing the at least one metadata configuration according to the one or more receiver stations and/or according to the message type to be transmitted.

7. The method of claim 1, wherein the message type is a vehicle-to-everything message.

8. A station configured to determine a need for a message content, the station configured to:
determine an anticipated need for a message content according to one or more receiver stations, wherein the anticipated need with respect to the message content is based on a need of the transmitting station;
compute at least one metadata configuration for the message content based on the determining of the anticipated need for the message content; and
augment the message content based on the computed at least one metadata configuration, wherein the metadata configuration specifies in which way the message content is to be adapted dependent on the one or more receiver stations and/or according to a message type to be transmitted.

9. A non-transitory computer-readable storage medium on which are stored instructions for determining a need for a message content for a transmitting station, the instructions, when executed by a computer, causing the computer to perform the following steps:
determining an anticipated need for a message content according to one or more receiver stations, wherein the anticipated need with respect to the message content is based on a need of the transmitting station;
computing at least one metadata configuration for the message content based on the determining of the anticipated need for the message content; and
augmenting the message content based on the computed at least one metadata configuration, wherein the metadata configuration specifies in which way the message content is to be adapted dependent on the one or more receiver stations and/or according to a message type to be transmitted.
